(19) United States
(12) Patent Application Publication
(10) Pub. No.: US 2023/0407780 A1
(43) Pub. Date: Dec. 21, 2023

(54) PISTONLESS COMBUSTION FLYWHEEL ENGINE DESIGN FOR LOW FUEL CONSUMPTION

(71) Applicant: HALO3 HOLDINGS LLC, DOVER, DE (US)

(72) Inventor: PAUL J. SOO, MIDWEST CITY, OK (US)

(21) Appl. No.: 18/247,638

(22) PCT Filed: Aug. 27, 2021
(86) PCT No.: PCT/US2021/048079

§ 371 Date: Mar. 31, 2023

Related U.S. Application Data
(60) Provisional application No. 63/071,288, filed on Aug. 27, 2020.

(51) Int. Cl. F02B 53/02; F01C 1/32; F01C 11/00; F02B 55/14

(52) U.S. Cl. CPC F02B 53/02; F02B 55/14; F01C 11/008; F01C 1/322

(57) ABSTRACT

A pistonless combustion flywheel engine includes two subsystems that work together to permit a rotary flywheel-disk to produce the conventional 4 strokes of a combustion engine within a single rotation of the flywheel-disk. The engine includes a flywheel-disk having a mass and is configured to deliver rotational inertia and torque. A primary subsystem comprises the flywheel-disk and an outer housing block configured to generate a combustion cycle. A second subsystem is located within the housing block and is configured to generate an intake cycle, a compression cycle, and an exhaust cycle. These cycles being performed externally to the flywheel-disk. Use of the primary subsystem and the second subsystem allows for the combustion cycle to occur on every revolution of the flywheel-disk.

### TECHNICAL FIELD

The present application relates to a method of minimizing fuel consumption in a combustion engine, and more particularly to a rotary styled combusting engine in the manner which eliminates the equivalence of pistons in a conventional internal combustion engine (ICE) or rotating chamber in the modern rotary engine in an efficient manner resulting in reduced fuel consumption.

### DESCRIPTION OF THE PRIOR ART

Aside from the advent of the rotary Wankel engine developed in the late 1950s, the fundamental design of the conventional internal combustion engine has not fundamentally changed in the last one-hundred-and-fifty-years. After its introduction, virtually all improvements have been in the areas of increasing the mechanical and thermodynamic efficiencies from its original design. Although significant strides in engineering efforts have been made resulting with some improvements over recent decades, fundamentally the combustion engine design still has considerable shortcomings.

In the conventional internal combustion engine (ICE), as seen in FIG. 1 in the drawings, the pistons and their respective piston rods are connected to a crankshaft in the main engine. The combustion force is transferred to the crankshaft after the piston has moved past top dead center to produce turning effort or torque, which rotates the crankshaft.

Every piston in a conventional piston engine must go through four distinct phases (intake, compression, power, and exhaust). At any given instance, only one piston in the system will provide positive energy to the crankshaft during the power stroke phase. This action from a single piston not only supplies rotational energies to the crankshaft but must supply the energies to move the remaining pistons through their respective phases of expelling exhaust, sucking in new air, and compressing the air/fuel mixture. These resulting dynamics remove energies from the crankshaft rather quickly.

The general equation for work done on an applied force that varies in a linear fashion within a single axis (i.e., up and down motion of a piston) is as follows:

$$W = {{\int }_{a}}^{b} F ( s ) \cdot ds \qquad Equation 1$$

Equation 1 becomes clear when examining the motion traveled by a single piston, as represented in FIG. 2 of the drawings. Ignoring friction, note that the piston is always accelerating (except for a couple of brief instances when the pistons reach maximum velocity.) Since the mass of the piston and rod is in continuous acceleration, the source of energy providing this motion (in this case of the main crank) is providing energy which takes away from its rotational inertia. If you look closely at FIG. 2, the maximum acceleration is seen to occur at TDC and BDC. This makes sense because the crank must deaccelerate the mass of the piston in one direction to a dead stop and re-accelerate the piston in the opposite direction from a dead stop. This takes quite a bit of effort from the crank. The average weight of pistons, rods, and pin assembly is approximately 30 lbs. That is quite sizable since that mass has to be moved a relatively short distance at high RPMs.

The invention described in the U.S. Pat. Nos. 6,796,285 and 7,500,462 describes an example of internal combustion engine that operates on a significantly different approach to the conventional combustion engine. Whereas the traditional internal combustion engine relies on the combusting downward motion of the pistons to drive the rotation of its crank, these patents describe variant of a rotary styled engine.

### SUMMARY OF THE INVENTION

It is an object of the present application to provide a split pistonless combustion flywheel engine. The system separates the combustion process into two bodies, the combustion and power cycle occurs in a first body while the intake and exhaust occur through a second body. The bulky mechanical links between the systems when combined is removed for more efficiently operated singular systems that operate together to complete the combustion process. The present system provides significant advantages over the conventional combustion engines. These advantages can be summarized as follows:
1. A reduction in the number of internal moving parts and the elimination of seals to reduce net friction and extend the life of the engine.
2. The conventional crankshaft has been replaced with a “flywheel-disk” of significant mass, which can store substantial amounts of rotational inertia, and deliver torque to the mechanical load.
3. The design offers a novel approach for delivering torque to the engine as it applies force near the extreme distal ends of the rotating “flywheel-disk” tangent to the direction of rotation. The split-combustion-chamber (see definition below) provides the key mechanism in transferring the combustive force tangent to the circumference of the flywheel-disk in the direction that rotates the flywheel in one direction.

The present system represents a radical departure in its approach from legacy systems resulting in substantial improvements over predecessors in terms of greater efficiency, performance control, and increased fuel economy.

Some key architectural differences between the present system and its predecessors are that the system of the present application includes architecture that separates the role of the four (4) major cycles or “strokes” into two groupings across two dedicated subsystems. The primary subsystem is the flywheel-disk and outer housing block where the actual “combustion cycle” occurs in which the forces from the expanding hot gasses are transferred to the crank. The remaining three cycles “Intake”, “compression” and “Exhaust” cycles are performed externally from the combustion space of the primary power plant in the second subsystem.

By distributing the aforementioned functional responsibilities across the two subsystems such that they are eliminated from the actual power plant, the present invention allows for the combustion cycle to occur on every revolution of the flywheel disk instead of on every two as required in the prior art described in the U.S. Pat. Nos. 6,796,285 and 7,500,462. This radical transformation in approach opens up a multitude of additional unconstrained design choices allowing more flexibility and optimization of key performance requirements. For example, in the present invention, the compression ratio is set by the compression subsystem independently from the dimensions of the bore and stroke dimensions.

The more important features of the assembly have thus been outlined in order that the more detailed description that follows may be better understood and to ensure that the present contribution to the art is appreciated. Additional features of the system will be described hereinafter and will form the subject matter of the claims that follow.

Many objects of the present assembly will appear from the following description and appended claims, reference being made to the accompanying drawings forming a part of this specification wherein like reference characters designate corresponding parts in the several views.

Before explaining at least one embodiment of the system in detail, it is to be understood that the assembly is not limited in its application to the details of construction and the arrangements of the components set forth in the following description or illustrated in the drawings. The assembly is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present assembly. It is important, therefore, that the claims be regarded as including such equivalent constructions insofar as they do not depart from the spirit and scope of the present assembly.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a conventional internal combustion engine.

FIG. 2 is a chart illustrating the power, acceleration, and velocity of pistons in the conventional internal combustion engine of FIG. 1.

FIG. 3 is a perspective view of a pistonless combustion flywheel engine of the present application where the split combustion chamber system representing the lower and upper halves on the flywheel-disk and stationary housing block respectively are shown.

FIG. 4 is a section view of a rotary engine of the present application having a flywheel disk residing inside the outer housing and its relationship to the various ports, gas injectors and spark system according to an embodiment of the present application.

FIG. 5 depicts the present invention as composing of two major subsystems represented by the flywheel-disk power plant and the high-pressure compressor working in unison.

FIGS. 6 and 6A-6H are sections views illustrating the various stages of the engine of the present application showing the positioning of the flywheel-disk with respect to the combustion cavities, fuel injectors, air intake and exhaust ports.

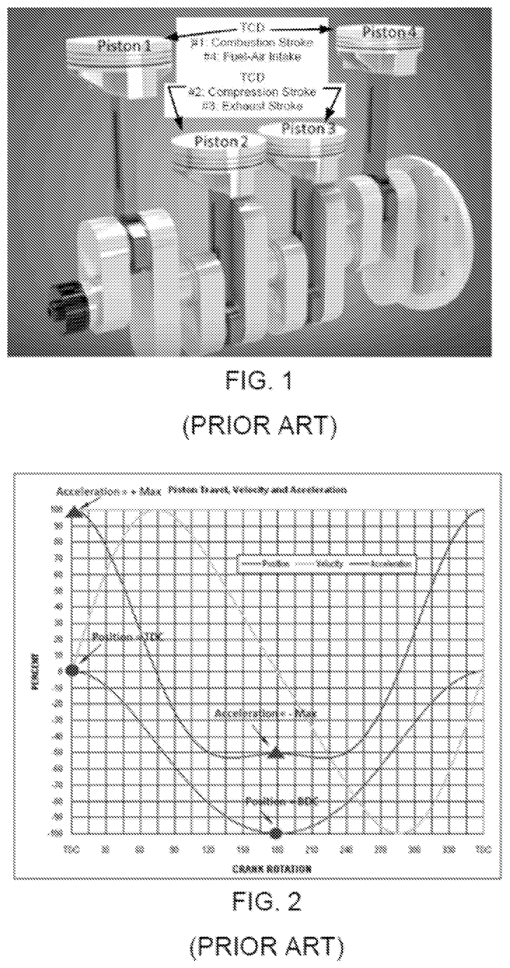

While the application is susceptible to various modifications and alternative forms, specific embodiments thereof have been shown by way of example in the drawings and are herein described in detail. It should be understood, however, that the description herein of specific embodiments is not intended to limit the application to the particular forms disclosed, but on the contrary, the intention is to cover all modifications, equivalents, and alternatives falling within the spirit and scope of the application as described herein.

### DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The new approach adopts much of the same thermodynamics and mechanical principles related to the classical combustion engine as it differs significantly on how the combustive energies are transferred to a rotating crankshaft. The present invention comprises of a stationary cylindrical outer housing block and a rotating cylindrical shaped flywheel-disk of significant mass sitting concentrically inside the cavity of the housing block allowing it to spin freely about its axial shaft(s).

The stationary cylindrical housing block represents the crucial elements which includes many of the basic components and elements typically found in an internal combusting engine with the exception that the inclusion of the aforementioned are place concentrically from around the outer circumference of the housing defining an arc pattern as oppose to the traditional linear layout. These components and elements provide the basic cycling functions of the engine which include any number of Gasoline Direct Injectors (GDI), spark plugs, combustion chambers, intake ports, exhaust ports, and valve mechanism assemblies making themselves present through within the interior walls of the housing and accessible to combustion cavities on the flywheel-disk which is further described below.

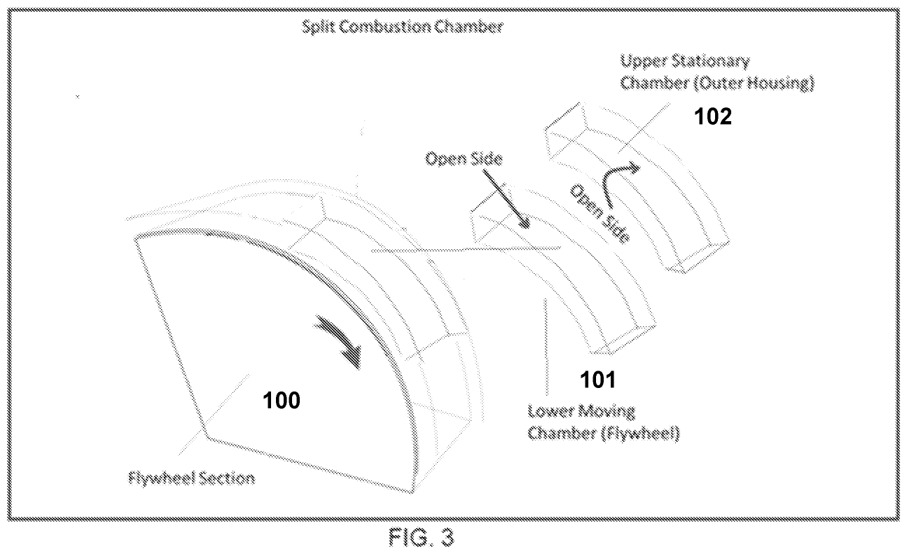

Referring now to FIG. 3 in the drawings. The flywheel-disk 100 is comprised of an axle shaft on either or both sides of the flywheel and is supported by one or both ends of the flywheel-disk through the means of shaft mounts securely fixed inside the housing structure. These shaft mounts can be fixed directly on the interior side of the housing lid or elsewhere internally within the housing.

The flywheel-disk 100 eliminates the need for the conventional crankshaft, and the two combustion cavities which are angularly displaced on the flywheel-disk 180 degrees from each other in this particular embodiment replaces the need for any pistons. In the present embodiment, it is likely the two cavities 101 on the flywheel-disk 100 would be designed to combust simultaneously to counter balance any asymmetric forces but not necessarily required. These combustion cavities 101 on the flywheel-disk 100 in combination with the upper combustion chambers 102 located on the outer block housing are referred to as the “split-combustion” set. The volume space within a split chamber replaces the equivalent combustion space normally found between the top of a piston and the combustion dome volume in the cylinder head at Top-Dead-Center (TDC) within a conventional combustion engine. The combustion cavities depicted as the lower moving chamber 101 in FIG. 3, are fixed on the flywheel-disk 100 and remain at its outer edge.

Referring now also to FIG. 4 in the drawings. This configuration represents a significant contrast to the approach to the claims in the prior art described in the U.S. Pat. Nos. 6,796,285 and 7,500,462. The flywheel-disk chamber 101 in the aforementioned patent references sits on internal gates which reciprocate continuously back and forth between the outer edge of the flywheel-disk and some distance radially inwards towards the centroid at a rapid rate. The flywheel-disk in the present invention requires no moving components making it a more reliable solution. The expanding hot gasses within the combustive cavities 101 and upper stationary chamber 102 of the housing translates the combustive forces tangent at the circumference of the flywheel-disk 100 from a radial distance with respect to the center of rotation. This creates a maximum torque as the upper and lower chamber 203, 204 walls of both the flywheel-disk 200 and combustion surface of the Rocker Pivot Combustion Gate 208 attached to the stationary housing pushes away from each other as depicted in FIG. 4. The Rocker Pivot Combustion Gate 208 assembly with its retractable gate component is designed to drop in place creating a smaller volume between the leading edge of the combustion chamber and the gate surface at the correct moment just before ignition. Conversely, the retractable gate component retracts upward allowing the flywheel-disk to continue to rotate when the combustion stroke completes. The Rocker Pivot Combustion Gate 208 assembly depicted in FIG. 4. is one such preferred embodiment for controlling the reciprocating motion of the gate but any mechanical or electro-mechanical such as cam and push rods or electric actuator. The diameter of the flywheel-disk 102 and its mass are significantly greater than that of a conventional engine crank allowing it to store larger amounts of kinetic energy in the form of rotational inertia.

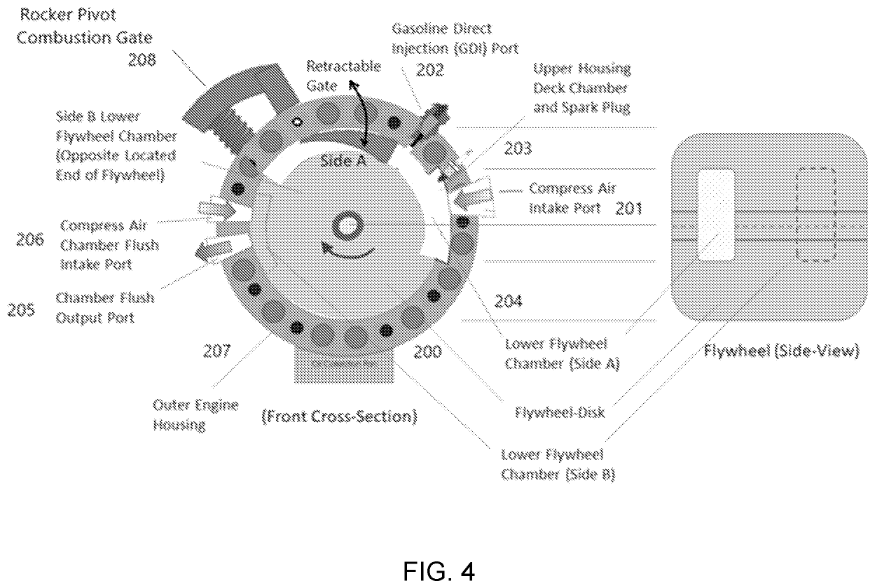

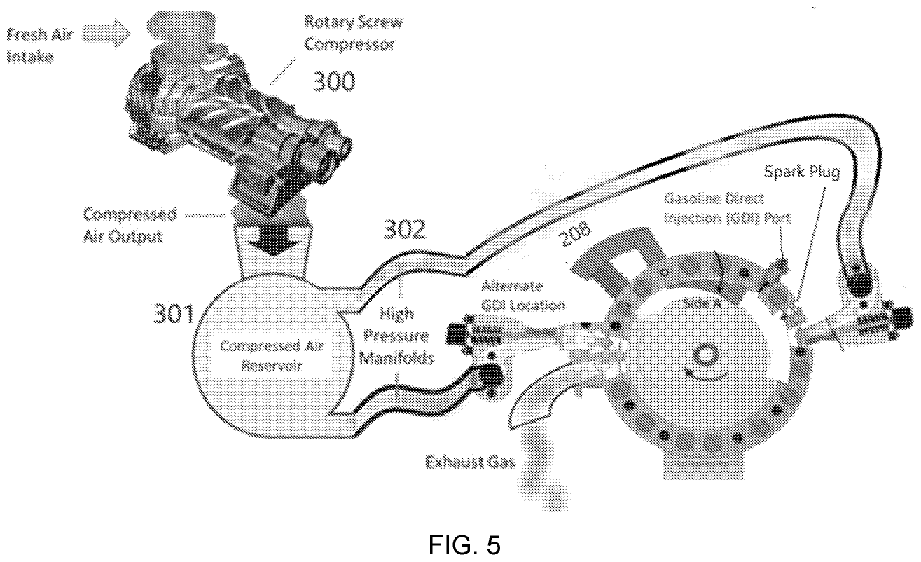

Referring now also to Figure FIG. 5 in the drawings, the sketch exposes the secondary subsystem responsible for supplying high pressure air to the flywheel-disk and housing block subsystem. This subsystem is a critical element in the present invention as it functions to supply high pressurized air to the flywheel-disk housing assembly for the following purposes:
a) Provide pre-compressed air to the split combustion chamber at the flywheel-disk 200.
b) Provide high velocity clean air to flush expended burnt fuel exhaust from the combustion chamber 205, 206. This action is referred to as “chamber rinsing.”

Central to the high-pressure air system is the rotary screw compressor 300. The rotary screw compressor 300 brings in ambient air through a filtered intake by means of positive displacement created by two helical rotors. The screw rotors then compress the incoming air as the rotor screws turn. During operation, the rotors turn and the spiral teeth mesh together forming chambers between the rotors and the casing wall. The spiral's geometry forces the air from a larger volume to a smaller volume sending compressed air out the discharge side into a high-pressure reservoir tank 301. An electronic control unit (ECU) manages the rotary screw compressor 300 to maintain a constant pressure in the reservoir tank 301. The source of the required energies to drive the screw compressor 300 could come either from the mechanical torque produced by the flywheel-disk 200 directly and/or indirectly from an electric motor supported by the systems electrical system much like what's found on any standard automobile system.

Referring now also to Figure FIG. 5, the high-pressure manifolds 302 are used to route the high pressurized air from the reservoir tank 301 to the compressed air intake port 201 and the chamber flush intake port 206 located on the outer housing block 207 of the flywheel-disk 200 power plant assembly. Either a mechanical cam or electronic control unit (ECU) can be used to control the valve assembly to administer the pressurized air to their respective ports in their correct timing. The high-pressure manifold system 301 can be designed to facilitate any number of intake ports 201 and the chamber flush intake ports 206 that exist on any given system. One possible embodiment of the current invention could include using the high-pressure manifold system 302 to chamber flush the upper stationary combustion chamber 102 located on the outer housing block 207 shortly after combustion.

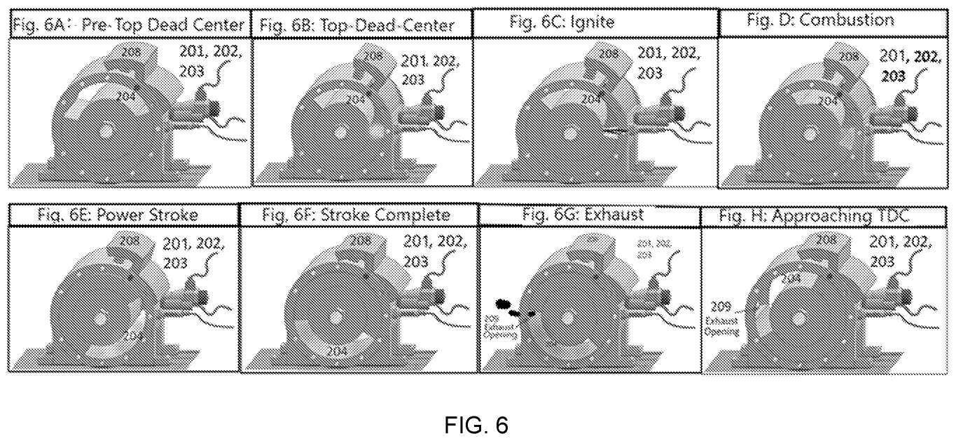

Referring now also to FIGS. 6A-6H in the drawings. The full cycle describing the process associated with the present invention is depicted in FIG. 6. As depicted in FIG. 6A, the flywheel disk 200 approaches Top-Dead-Center (TDC) as defined later in this section. At the specific point the leading edge of lower chamber 204 of the flywheel disk 200 is in the precise location of the combustion gate 208, the spring-loaded gate forces it down in place inside the chamber 204 initially creating a small volume between the gate's combustion surface and the leading edge of the chamber 204 as depicted in FIG. 6B.

This is where the entire process is initiated as the lower chamber 204 is aligns with the compressed air intake valve 201, gas-direct-injector (GDI) 202, and spark plug 203. The ECU opens valves to the air injectors 201 along with spraying fuel into the lower combustion chamber 204.

Referring to FIG. 6C, and following the injection of the fuel-air mixture into the lower chamber 204, the ECU ignites the spark plug 203 causing the air-fule mixture to ignite. This resulting combustion as depicted in FIG. 6D causes the expanding hot gasses to expand and forces the leading edge of the lower chamber 204 to push away from the opposite end against the surface of the combustion gate that is stationary with respects to the outer housing. This causes the flywheel disks 200 to rotate clock-wise in the example diagrams in FIG. 6.

The engine reaches its end of the power stroke when the trailing approaches the backside if the combustion gate 208 as depicted in FIG. 6E. The curved lever arm of the combustion arm assembly 208 gradually raises the gate up retracting up into the housing and away from the flywheel before the trailing edge of the chamber reaches it preventing damage. Once the combustion gate 208 is retracted up, there are no longer combustive forces pushing away against any opposing surfaces and the flywheel disk at this point is basically coasting from its momentum as illustrated in FIG. 6F. Lastly, before the flywheel disk approaches TDC, the pressurized exhaust is allow to escape from the exhaust opening 209 in the housing as depicted in FIG. 6G.

Alternatively, to the exhaust method forementioned in FIG. 6G, the instance when the lower flywheel-disk cavity overlaps with both the compressed air chamber flush intake port 206 and output port 205 (see FIG. 4.). This process is referred to as the chamber rinse cycle and is depicted in FIG. 5. During this cycle the valve at the intake port 206 opens producing a negative pressure condition at the output port 205 which causes high velocity air to push through the channels and rinse the exhaust gasses from the lower cavity 204. Alternatively, the upper chamber cavity 203 can also be flushed out in a similar manner.

The present invention allows for unparallel benefits of saving fuel during low load conditions. For instance, in a vehicle, the electronic control unit (ECU) can simply stop delivering fuel and spark to the combustion chamber when vehicle is going down a hill. The ECU can be programmed to apply fuel and spark only when required based on the load. The present application uses the terms “Coast Mode” and “Inertia Throttling” to describe this concept.

Following the final chamber rinse stage, the momentum produced will bring the flywheel-disk 200 back to the intake position again and the entire process is repeated.

The system of the current application has many advantages over the prior art including at least the following:
1. The dimensions, mass, and radius of the flywheel-disk allows for the flexible configuration of for controlling the desired amount of rotational inertia desired.
2. The split-combustion-chamber in conjunction with the Rocker Pivot Combustion Gate assembly provides a mechanism to translate the combustive reaction to resultant force that is tangent at the outer circumference of the flywheel-disk provide more efficient way of translating rotating energy to the crank and minimizes energy losses from vibrations.
3. With the exception of the flywheel-disk itself, the rotating flywheel contains no moving components, making it potentially more superior in terms of reliability, longevity and fuel-efficient reduction of friction between internally rubbing parts.
4. Three out of the four cycles defined by the traditional internal combustion engine has been eliminated from the combustion space allowing for an extremely flexible design by eliminating many parametric dependencies, constraints and performance tradeoffs currently exists in conventional engine design approach.
5. The ability to deliver power more frequently by combusting on every rotation of the crank instead of every other two crank revolutions.
6. Provides a simpler and more reliable method of implementing “Coast Mode”, or in other words, regulating performance of a spark and compression to selectively let flywheel section 100 rotated freely.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A pistonless combustion flywheel engine, comprising:
a flywheel-disk having a mass and configured to deliver rotational inertia and torque;
a primary subsystem comprising the flywheel-disk and an outer housing block configured to generate a combustion cycle;
a second subsystem located within the housing block configured to generate an intake cycle, a compression cycle, and an exhaust cycle, these cycles being performed externally to the flywheel-disk;
wherein use of the primary subsystem and the second subsystem allows for the combustion cycle to occur on every revolution of the flywheel-disk.

2. The engine of claim 1, wherein the flywheel-disk rotates within the outer housing block.

3. The engine of claim 1, wherein the flywheel-disk includes a cavity on an outer surface.

4. The engine of claim 3, wherein the outer housing block includes a cavity such that the cavities of the outer housing and the flywheel-disk pass one another as the flywheel-disk rotates within the outer housing block.

5. The engine of claim 1, wherein the primary subsystem includes a split-combustion cavity set, the combustion cavity being split between the flywheel-disk and the outer housing block.

6. The engine of claim 1, further comprising:
a compressed air reservoir in communication with an intake port in the outer housing block, compressed air in the compressed air reservoir being pushed into the split-combustion cavity set for ignition.

7. The engine of claim 1, further comprising:
a compressed air reservoir in communication with an intake port in the outer housing block, the compressed air reservoir configured to hold compressed air.

8. The engine of claim 7, wherein the compressed air being inserted into a cavity of the flywheel-disk and the outer housing block simultaneously.

9. The engine of claim 8, further comprising:
a fuel port and a spark plug configured to induce the power cycle.

10. The engine of claim 9, wherein the power cycle rotates the flywheel-disk such that the cavity of the flywheel-disk rotates within the outer housing block and is selectively discharged through a port in the outer housing block.

11. The engine of claim 1, further comprising:
a rocker pivot combustion gate coupled to the outer housing block.

12. The engine of claim 11, further comprising:
a retractable gate in communication with the rocker pivot combustion gate and configured to pivot so as to selectively extend into the cavity of the flywheel-disk.
